(19) United States
(12) Patent Application Publication
(10) Pub. No.: US 2021/0283953 A1
(43) Pub. Date: Sep. 16, 2021

(54) AXLE DEVICE FOR VEHICLE

(71) Applicant: TOYOTA JIDOSHA KABUSHIKI KAISHA, Toyota-shi (JP)

(72) Inventor: Kenichiro HAYASHI, Ohbu-shi (JP)

(73) Assignee: TOYOTA JIDOSHA KABUSHIKI KAISHA, Toyota-shi (JP)

(21) Appl. No.: 17/160,459

(22) Filed: Jan. 28, 2021

(30) Foreign Application Priority Data
Mar. 11, 2020 (JP) 2020-041662

(51) Int. Cl. B60B 35/12; B60B 35/18; F16H 57/04; F16H 57/029

(52) U.S. Cl. CPC B60B 35/122; B60B 35/18; B60K 2001/001; F16H 57/029; F16H 57/0471

(57) ABSTRACT

An axle device includes a power unit including an electric motor and a differential. A drive shaft transmits power distributed by the differential to a drive wheel. The drive shaft is supported by an axle pipe via a hub bearing. The right and left axle pipes are respectively fixed to right and left portions of the axle frame, and the power unit is fixed to the axle frame.

### CROSS-REFERENCE TO RELATED APPLICATION

This application claims priority to Japanese Patent Application No. 2020-041662 filed on Mar. 11, 2020, incorporated herein by reference in its entirety.

### BACKGROUND

### 1. Technical Field

The present disclosure relates to an axle device for a vehicle and, in particular, to an axle device that is integrated with a power unit including an electric motor.

### 2. Description of Related Art

An axle device for a vehicle typically includes: an axle housing that extends in a right-left direction of the vehicle; a differential that is accommodated in a central portion of the axle housing; and a drive shaft that extends to the right and left from the differential in the axle housing and has an axle hub at each end. In Japanese Patent Application Publication No. 7-32990 (JP 7-32990 A), an axle device (a transaxle device) that transmits output of a travel motor (30) to right and left drive wheels (21) is described. The member names and the reference numerals in ( ) described above are the member names and the reference numerals used in JP 7-32990 A and are not related to member names and reference numerals used for the description of an embodiment of the present application.

### SUMMARY

The axle device for the vehicle receives a load from a road surface. The axle housing needs to have enough strength to withstand this received load. In the case where the central portion of the axle housing, in which the differential is accommodated, is enlarged due to accommodation of the electric motor in addition to the differential, for example, weight of the axle housing is possibly increased in order to secure the strength and rigidity of such a portion.

The present disclosure has a purpose of suppressing a weight increase of a portion, in which a differential and the like are accommodated, in an axle device.

An axle device for a vehicle according the present disclosure is an axle device of a power unit integrated type and includes a power unit including: an electric motor; a differential configured to distribute power from the electric motor to right and left drive wheels; and a case accommodating the electric motor and the differential. The axle device further includes: right and left drive shafts, to each of which the drive wheel is attached at a tip, and each of which is configured to transmit the power distributed by the differential to the drive wheel; right and left axle pipes, each of which accommodates a part of a corresponding one of the right and left drive shafts and supports a corresponding one of the right and left drive shafts; and an axle frame fixing the right and left axle pipes and connecting the right and left axle pipes. The power unit is fixed to the axle frame.

Since the axle frame is provided to connect the right and left axle pipes, it is possible to suppress a load from being received by the power unit.

The axle device for the vehicle may have a lubrication system for a bearing that supports the drive wheel and a lubrication system in the power unit which are independent of each other. As a result, the axle pipes need not be joined to the power unit. Thus, it is possible to suppress the load from being received by the power unit.

The case for the power unit may have an opening through which the drive shaft runs, and an oil seal may be arranged in the opening to seal the case and keep a lubricant for lubricating inside of the power unit in the case. With a simple configuration, the inside of the power unit can be a tightly-sealed space in terms of the lubricant.

The power unit may be fixed to the axle frame at positions in front of and behind the power unit. In this way, the power unit can be supported firmly.

The axle frame may have: a front beam that is located in front of the drive shaft and extends in a right-left direction; and a rear beam that is located behind the drive shaft and extends in the right-left direction. A front portion of the power unit may be fixed to the front beam. A rear portion of the power unit may be fixed to the rear beam.

Since the axle frame is provided, the load is suppressed from being received by the power unit, and there is no need to increase strength of the power unit. Therefore, it is possible to suppress a weight increase of the power unit.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a schematic view in which an axle device according to an embodiment is seen in a plan view;

FIG. 2 is a schematic view in which the axle device in FIG. 1 is seen in a side view;

and

FIG. 3 is s a schematic view in which an axle device according to another embodiment is seen in a plan view.

### DETAILED DESCRIPTION OF EMBODIMENTS

A description will hereinafter be made on embodiments of the present disclosure with reference to the drawings. Unless otherwise particularly specified, terms representing relative positions and directions, such as front, rear, right, left, up, and down, in the description below indicate relative positions and directions of a vehicle. In the drawings, a direction indicated by an arrow FR is the front, a direction indicated by an arrow UP is upside, and a direction indicated by an arrow LH is the left.

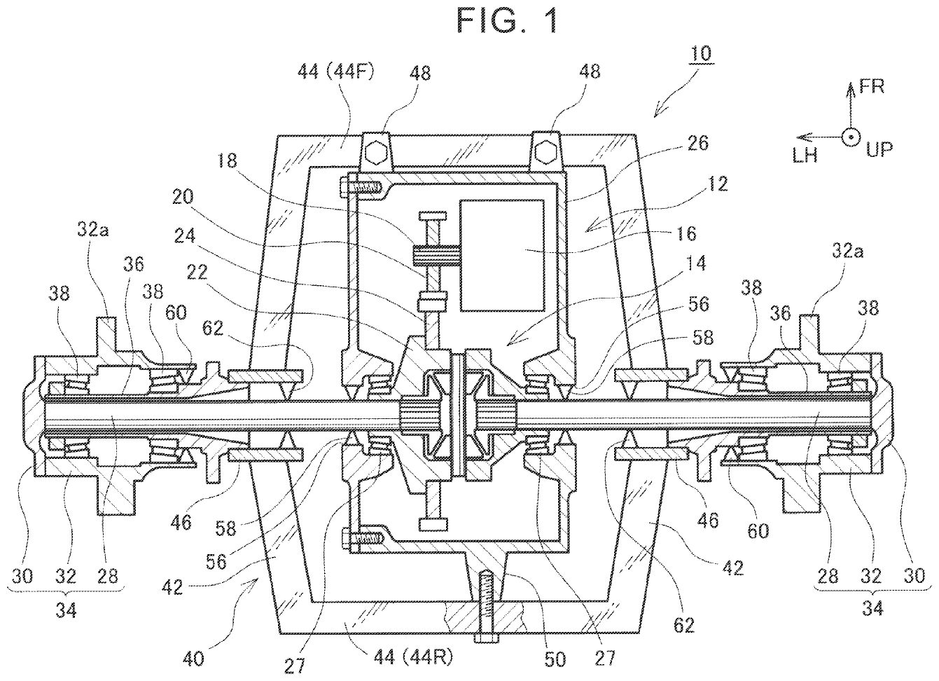

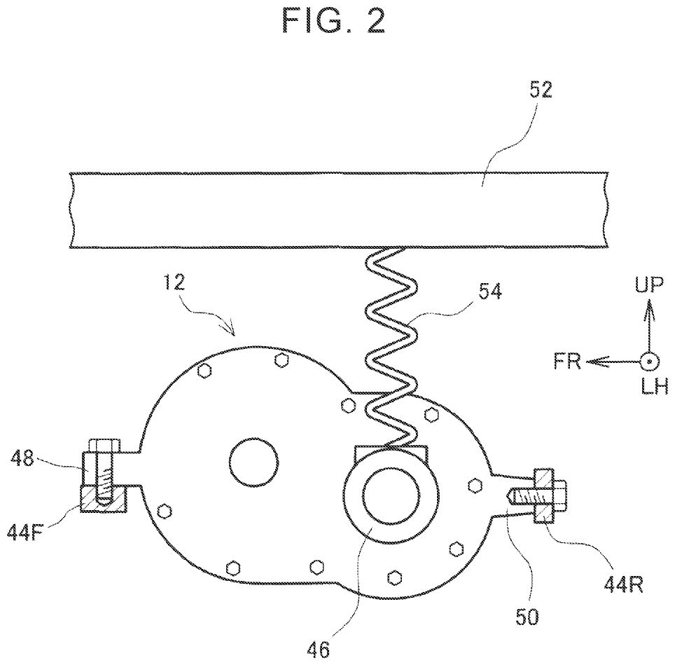

FIG. 1 is a plan view schematically illustrating an outline configuration of an axle device 10 for a vehicle. In FIG. 1, in order to illustrate an internal structure, a part of the axle device 10 for the vehicle is illustrated in cross section. FIG. 2 is a side view of the axle device 10 and is particularly a side view of a power unit 12 that is provided in the axle device 10.

The axle device 10 is a device that connects right and left drive wheels (not illustrated) of the vehicle, and is a component of a suspension of an axle suspension type. In a right-left direction, the axle device 10 includes, in a central portion, a differential 14 and the power unit 12 including an electric motor 16 for driving the vehicle. An output gear 20 is fixed to an output shaft 18 of the electric motor 16, and the output gear 20 meshes with a ring gear 24 that is fixed to a differential case 22 of the differential 14. The output gear 20 and the ring gear 24 may be a reduction gear pair that reduces output of the electric motor 16 and transmits the reduced output to the differential 14. In order to obtain a high reduction ratio, the output of the electric motor 16 may be transmitted via a gear train including plural gear pairs. The differential 14 and the electric motor 16 including the gear pair for connecting these are accommodated in a power unit case 26. The differential 14 is supported by the power unit case 26 via a case bearing 27. A stator of the electric motor 16 is fixed to an inner wall surface of the power unit case 26 by a bolt.

Axle shafts 28, each of which extends toward a corresponding one of the right and left drive wheels, are joined to the differential 14. A joint flange 30 is fixed to a tip of each of the axle shafts 28, and an axle hub 32 is fixed to the joint flange 30. A wheel (not illustrated) for the drive wheel is joined to a flange 32a of the axle hub 32. The axle shaft 28, the joint flange 30, and the axle hub 32 constitute a drive shaft 34 to which the drive wheel is attached at a tip.

The axle hub 32 is supported by a substantially-cylindrical axle pipe 36 via a hub bearing 38. The axle pipe 36 is coaxially arranged in a manner to surround the axle shaft 28. That is, the axle device 10 is of a full-floating support type. Instead of this, the axle device 10 may be of a semi-floating support type in which the drive wheel is directly attached to a flange provided at the tip of the axle shaft. In the semi-floating support type, the bearing is arranged between the axle shaft and the axle pipe, and the axle shaft is supported by the axle pipe via the hub bearing.

The right and left axle pipes 36 are fixed to an axle frame 40, and the axle frame 40 connects the right and left axle pipes 36 in a manner to bridge a gap therebetween. The axle frame 40 has a substantially rectangular frame shape and includes: two vertical members 42, each of which extends in a front-rear direction of the vehicle; and two lateral beams 44, each of which extends in the right-left direction of the vehicle and connects the two vertical members 42. Each of the vertical members 42 includes a support pipe 46 that is joined to a base end of the axle pipe 36. As illustrated in the drawing, a base end portion of the axle pipe 36 is fitted to the inside of the support pipe 46, and these axle pipe 36 and support pipe 46 are fixedly joined to each other. The axle shaft 28 extends through an internal space of the support pipe 46. In the case where the two lateral beams 44 have to be distinguished from each other, the lateral beam that is located in front of the axle shaft 28 is described as a front lateral beam 44F, and the lateral beam that is located behind the axle shaft 28 is described as a rear lateral beam 44R.

The power unit 12 is fixed to the axle frame 40. More specifically, a front joint piece 48 that is provided in a front portion of the power unit 12 is joined to the front lateral beam 44F of the axle frame 40 by a bolt. In addition, a rear joint piece 50 that is provided in the power unit 12 is joined to the rear lateral beam 44R of the axle frame 40 by a bolt. Instead of one or both of the front joint piece 48 and the rear joint piece 50, a joint piece may be provided in a manner to bulge from a side surface of the power unit 12 in the right-left direction, and such a joint piece may be joined to the vertical member 42 by a bolt.

The axle device 10 is suspended from a body frame 52 of the vehicle by a spring 54 and a link mechanism (not illustrated) (see FIG. 2). The link mechanism controls a posture of the axle device 10. The spring 54 buffers a load received from a road surface. The spring 54 may be a coil spring, and a lower end of the spring 54 is fixed to the support pipe 46. In addition, a damper (not illustrated) may be arranged between the axle device 10 and the body frame 52 in order to reduce vibration of the axle device 10.

An opening 56, through which the axle shaft 28 runs, is provided on a side surface of the power unit case 26, and an oil seal 58 is arranged in the opening 56. The oil seal 58 seals the power unit case 26 to keep a lubricant for lubricating the differential 14, the electric motor 16, the output gear 20, and the ring gear 24 in the power unit case 26. A space for accommodating the hub bearing 38, which supports the axle hub 32, is sealed by an oil seal 60 arranged between the axle hub 32 and the axle pipe 36 and an oil seal 62 arranged between the axle shaft 28 and the support pipe 46. With arrangement of such oil seals 58, 60, 62, a lubrication system in the power unit 12 and a lubrication system for the hub bearing 38, which supports the axle hub 32, are independent of each other.

The right and left axle pipes 36 and the axle frame 40 constitute an integral structure that extends between the right and left drive wheels. This structure is suspended from the body frame 52, and the power unit 12 is fixed to this structure. The axle pipe 36 and the axle frame 40 receive the load from the road surface. Thus, the load is suppressed from being received by the power unit case 26. As a result, strength and rigidity requested for the power unit case 26 are not increased, which can suppress a weight increase of the power unit case 26. In addition, the power unit case 26 can be used with the power unit that is used for a vehicle of an independent-suspension type. In the case of the independent suspension, the power unit is arranged on the spring. Thus, the load received from the road surface is hardly transmitted to the power unit. For such a reason, the power unit case can have light weight. In this axle device 10, since the load received by the power unit is low, a light-weight power unit, such as the power unit for the vehicle of the independent-suspension type, can be adopted. In addition, since the lubrication system for the power unit 12 and the lubrication system for the hub bearing 38 are independent of each other, the lubrication system for the power unit 12 and the lubrication system for the hub bearing 38 can be adopted as lubrication systems for the power unit of the independent-suspension type without making a change to the lubrication system for the power unit 12 and the lubrication system for the hub bearing 38.

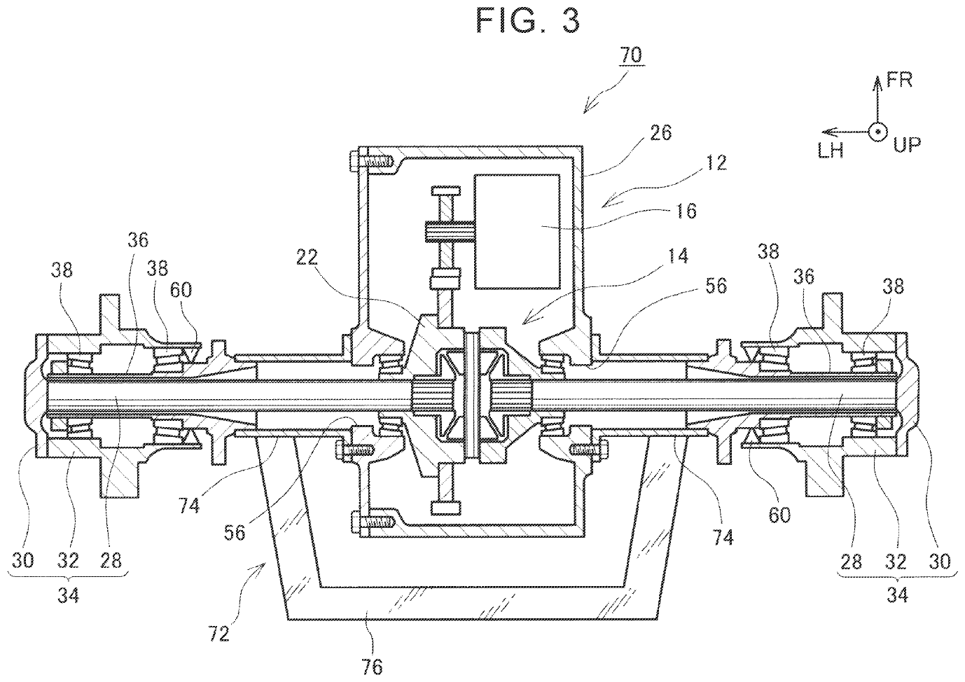

FIG. 3 is a view illustrating an axle device 70 according to another embodiment. Similar components to those of the above-described axle device 10 are denoted by the same reference numerals, and the description thereon will not be made. The axle device 70 includes an axle frame 72 that fixes the right and left axle pipes 36 in a manner to bridge a gap therebetween. The axle frame 72 includes a support pipe 74 that is joined to the base end of the axle pipe 36 in a similar manner to the above-described support pipe 46. The support pipe 74 has an inner end that reaches the power unit 12, and is fixed to a portion of the power unit 12 around the opening 56 by a bolt or the like, for example. The axle device 70 further has a single coupling beam 76 that couples the right and left support pipes 74. The coupling beam 76 is substantially U-shaped, and both ends of the coupling beam 76 are joined to the right and left support pipes 74. In order to offset a dimensional difference in the right-left direction between the power unit 12 and a gap between the right and left support pipes 74, an adjustment shim may be provided between the power unit case 26 and each of the support pipes 74.

In the axle device 70, an oil seal is not arranged in the opening 56 of the power unit case 26, and an oil seal is not arranged between the support pipe 74 and the axle shaft 28. Accordingly, a space for accommodating the hub bearing 38 and a space in the power unit case 26 communicate with each other and are lubricated by the common lubricant.

Also in the axle device 70, the right and left axle pipes 36 and the axle frame 72 constitute an integral structure. Thus, compared to a case where the coupling beam 76 is not provided, the load received by the power unit case 26 can be suppressed to be low.

What is claimed is:

1. An axle device for a vehicle comprising:
a power unit including
an electric motor
a differential configured to distribute power from the electric motor to right and left drive wheels, and
a case accommodating the electric motor and the differential;
right and left drive shafts, to each of which the drive wheel is attached at a tip, and each of which is configured to transmit the power distributed by the differential to the drive wheel;
right and left axle pipes, each of which accommodates a part of a corresponding one of the right and left drive shafts and supports a corresponding one of the right and left drive shafts; and
an axle frame fixing the right and left axle pipes, connecting the right and left axle pipes, and further fixing the power unit.

2. The axle device for the vehicle according to claim 1, wherein a lubrication system for a bearing that supports the drive wheel and a lubrication system in the power unit are independent of each other.

3. The axle device for the vehicle according to claim 2, wherein the case has an opening through which the drive shaft runs, and an oil seal is arranged in the opening to seal the case and keep a lubricant for lubricating inside of the power unit in the case.

4. The axle device for the vehicle according to claim 1, wherein the power unit is fixed to the axle frame at positions in front of and behind the power unit.

5. The axle device for the vehicle according to claim 4, wherein:
the axle frame has: a front beam that is located in front of the drive shaft and extends in a right-left direction; and a rear beam that is located behind the drive shaft and extends in the right-left direction;
a front portion of the power unit is fixed to the front beam; and
a rear portion of the power unit is fixed to the rear beam.
